(19) United States
(12) Patent Application Publication
(10) Pub. No.: US 2019/0303832 A1
(43) Pub. Date: Oct. 3, 2019

(54) WEB-BASED TRADE COMPLIANCE PROGRAM BENCHMARKING TOOL

(71) Applicants: Sean David Perkins, Washington, DC (US); Matthew Aaron Goldstein, Potomac, MD (US)

(72) Inventors: Sean David Perkins, Washington, DC (US); Matthew Aaron Goldstein, Potomac, MD (US)

(21) Appl. No.: 15/939,280

(22) Filed: Mar. 29, 2018

(51) Int. Cl. G06Q 10/06; G06Q 40/04

(52) U.S. Cl. CPC G06Q 10/06393; G06Q 10/067; G06Q 40/04

(57) ABSTRACT

A method and system for benchmarking a trade compliance program against government agency standards comprised of a database of government agency standards cross-referenced to trade compliance program elements and a web-based interface for user access to the trade compliance program elements. The user inputs information regarding the trade compliance program elements present in the user's trade compliance program. The method and system cross-reference the program elements present in the user's trade compliance program with government agency standards on the database and provide a count of government agency standards met by the user's trade compliance program, and provide a count of government agency standards that are not met by the user's trade compliance program.

### CROSS-REFERENCE TO RELATED APPLICATIONS

Not Applicable

### STATEMENT REGARDING FEDERALLY SPONSORED RESEARCH

This invention is not part of any federally sponsored government research or development.

### BACKGROUND OF THE INVENTION

### Field of the Invention

This invention relates to a method and system for benchmarking a trade compliance program against government agency standards for trade compliance programs.

### Description of Related Art

United States export and import control laws are broad, complex, and violations are subject to significant fines and other penalties. Companies involved in export and import activities develop, implement, and maintain trade compliance programs to establish policies and procedures for compliance with United States export and import control laws and, at times, the export and import control laws of other countries.

### BRIEF SUMMARY OF THE INVENTION

The present invention relates to a method and system for benchmarking a trade compliance program against government agency standards for trade compliance programs using a database of government agency standards that cross-references trade compliance program elements, organized under program modules accessible in a web-based tool. In the preferred embodiment, the method and system can match specific trade compliance program elements present in a user's trade compliance program to corresponding government agency standards and identify and provide a count of government agency standards met by the user's trade compliance program, and identify and provide a count of government agency standards that are not met by the user's trade compliance program.

### BRIEF DESCRIPTION OF THE DRAWINGS

FIG. 1 illustrates the primary content of the government agency standards database.

FIG. 2 illustrates the steps involved in one embodiment of the present invention.

FIG. 3 illustrates one example of a web page layout configured for tracking trade compliance program elements corresponding to government agency standards, by program element.

FIG. 4 illustrates one example of a web page layout configured for tracking trade compliance program elements corresponding to government agency standards, by program module.

FIG. 5 illustrates one example of a web page layout configured for tracking trade compliance program elements corresponding to government agency standards, by government agency.

### DETAILED DESCRIPTION OF THE INVENTION

United States export and import control laws are broad and complex. Violations are subject to significant fines and other penalties. These laws are enforced by multiple government agencies, each with their own requirements.

The effectiveness of trade compliance programs (also known as “international trade compliance programs”) is a factor that United States government agencies consider in deciding whether to criminally charge a company, negotiate a plea, enter into a civil settlement or issue a warning for violations of export and import control laws. Because of this, and for other reasons, companies involved in export and import activities develop, implement, and maintain trade compliance programs.

The typical trade compliance program contains program elements that address export and import control laws as well as related federal laws, to include national security laws on handling national security classified and controlled unclassified information, foreign corrupt practices, foreign boycott requests, and laws requiring accurate financial reports to shareholders.

The United States Departments of State, Commerce, Homeland Security, Treasury, Justice, and other federal government agencies publish standards that they use to evaluate the effectiveness of trade compliance programs.

Many of the agency standards are overlapping or duplicative, carrying added importance from their repeated appearances across government sources. For example, many agencies responsible for enforcement of export and import control laws require a clear management statement of commitment to compliance with export and import control laws. The presence of this standard across government sources underscores its importance to effective trade compliance programs.

Various web-based methods and systems (“tools”) exist to manage compliance with export and import control laws. These tools generally focus on determining transaction-specific compliance or focus on calculating user risk and exposure to violations of export and import control laws. These tools do not benchmark compliance program elements against a database of applicable government agency standards for compliance programs.

Transaction-specific tools focus on compliance with licensing, reporting, prohibited party screening, and other requirements for a particular export or import transaction. They may also focus on management of government agency authorizations for specific transactions.

Risk and exposure calculating tools focus on measuring environmental factors of the user's business, such as export product type, market geography, sales channels, export volume, and offshore activities for use in plotting on matrices. These tools are complicated, often involving formulas, weighted values, and many variables.

Hence, there is a need for a non-transaction specific method of trade compliance management that is simple, does not involve plotting risk and exposure or other variables on matrices, and that benchmarks overall trade compliance program elements against government agency standards.

The present invention is a method and system for benchmarking the quality of a trade compliance program against government agency standards. It includes a database of government agency standards cross-referenced to compliance program elements required by the standards and a web-based interface for access to the program elements by a user.

The term “benchmarking,” as used herein, means a standard or point of reference against which things may be compared or assessed.

The term “agency source document,” as used herein, means a written guidance, consent agreement, or other document issued or otherwise released by a government agency that sets forth standards that corresponds to a trade compliance program element.

The term “program element,” as used herein, means a policy or process requirement corresponding to one or more government agency trade compliance program standards.

The term “program module,” as used herein, means a top-level description of the common topic or purpose served by a group of program elements.

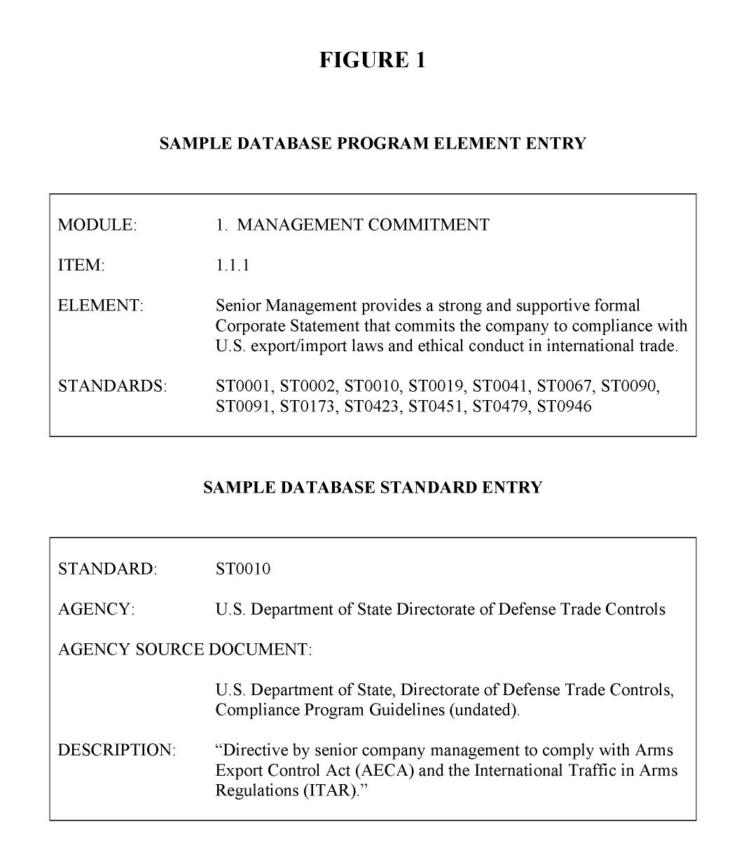

FIG. 1 illustrates the primary government agency standards database fields.

As shown in FIG. 1, in accordance with the preferred embodiment of the invention, government agency standards are translated and merged into specific program elements.

Program elements may have more than a single corresponding government agency standard. Each program element is then organized under a specific program module. Each module has multiple program elements.

### PROGRAM MODULES

1. MANAGEMENT COMMITMENT

2. PROGRAM SETUP AND ADMINISTRATION

3. TRAINING

4. JURISDICTION, CLASSIFICATION, AND MARKING

5. PHYSICAL SECURITY AND ACCESS CONTROL

6. TRANSACTION SCREENING

7. AUTHORIZATION MANAGEMENT

8. EXPORT/IMPORT CLEARANCE

9. THIRD PARTY MANAGEMENT

10. RECORDKEEPING

11. AUDITS AND ASSESSMENTS

12. HANDLING VIOLATIONS

The above list of modules is exemplary and not meant to be exhaustive or otherwise restrictive. Modules may be merged, split or removed. Additional modules may be added to address conceptually distinct groups of program elements.

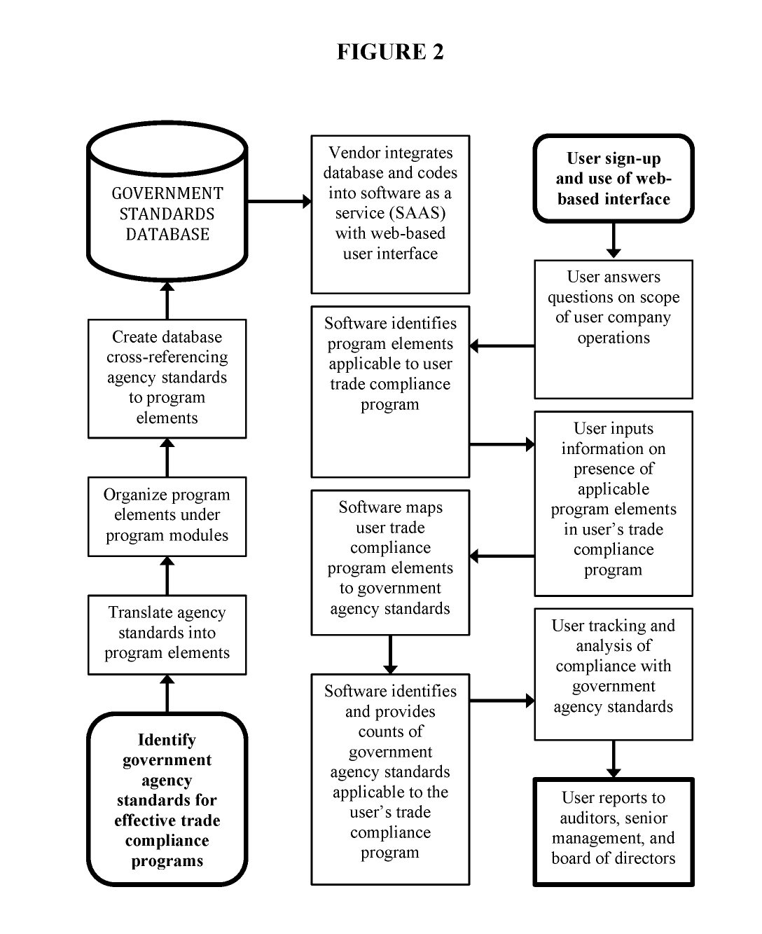

FIG. 2. illustrates the steps involved in the preferred embodiment of the invention.

As shown on FIG. 2, following creation of the government standards database, a vendor integrates the database and code into software as a service (SAAS) with a web-based user interface that allows the database to be accessed from a computer with an Internet connection and web browser.

As further shown in FIG. 2, the user signs up with the service and begins use of the web-based user interface. The user answers preliminary questions relating to the scope of company operations (i.e., types of items exported or imported, international travel by employees, etc.). The tool then identifies the program elements applicable to the user's trade compliance program.

The user next inputs information regarding the status of the user's trade compliance program implementation of policies and procedures addressing each program element applicable to the user's trade compliance program.

The web-based interface then maps each program element implemented in the user's trade compliance program to corresponding government agency standards, by program element, by program module, and by government agency, with a level of detail sufficient to reveal specific government agency source documents for program elements.

As further shown in FIG. 2, and in accordance with at least one other embodiment of the invention, the web-based system can generate reports based on counts of government agency standards corresponding to each program element implemented in the user's trade compliance program for use in reports to the user's auditors, senior management, and board of directors. The reports can reveal program growth over time, increase senior management and board member confidence in compliance, and support executive officer internal control certifications.

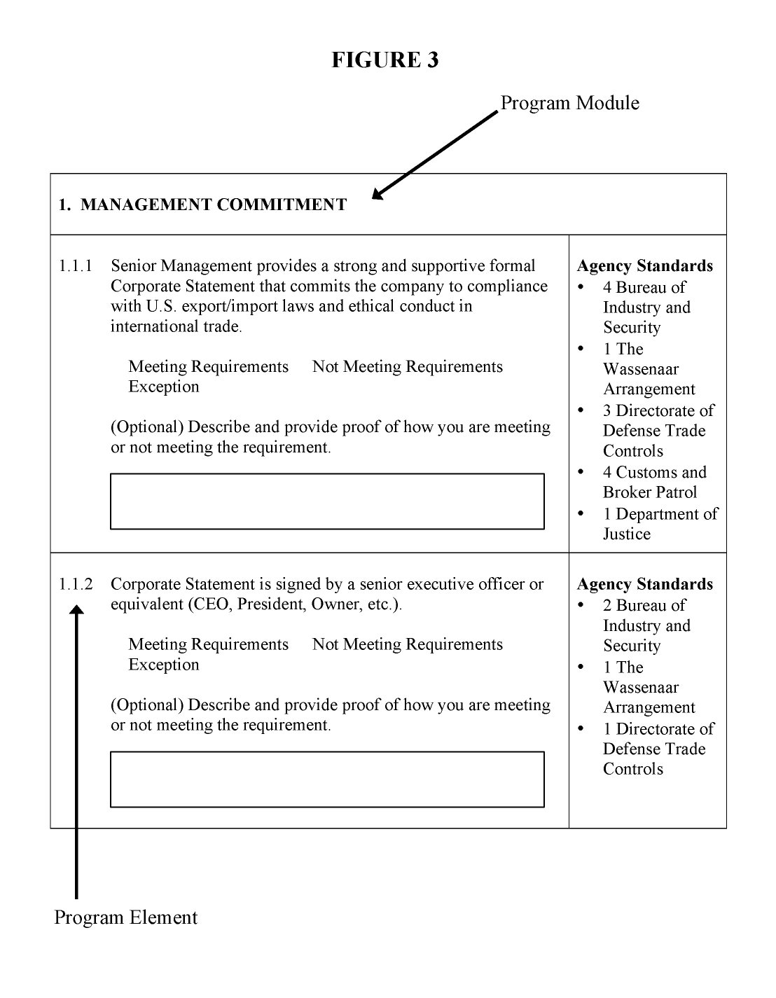

FIG. 3 illustrates a web page layout configured for tracking trade compliance program elements corresponding to government agency standards, by program element.

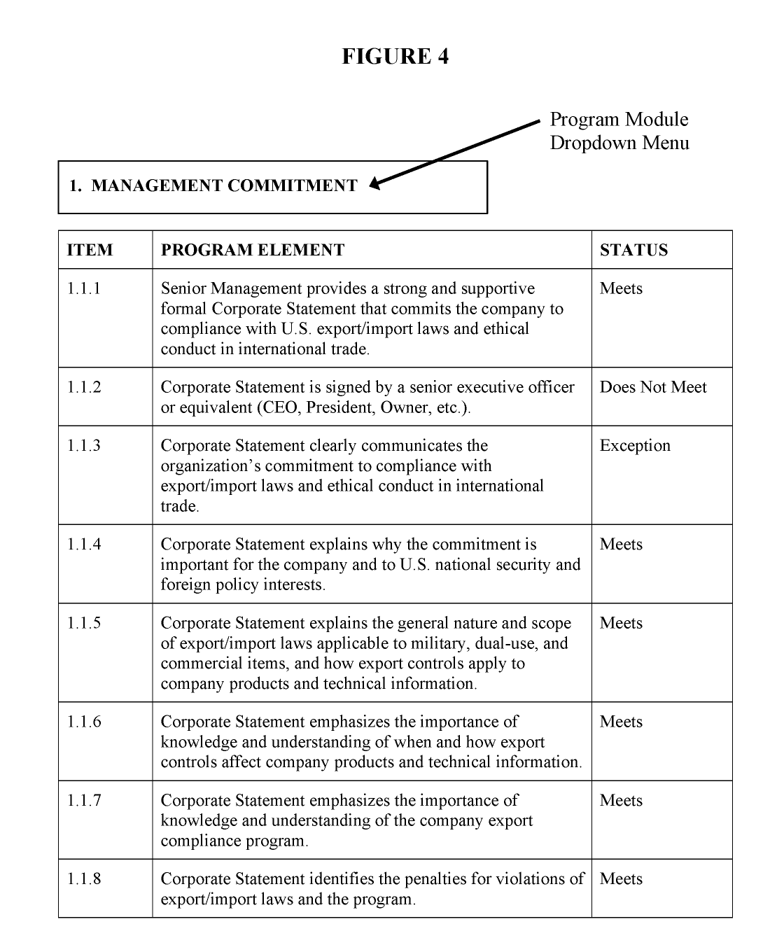

FIG. 4 illustrates a web page layout configured for tracking trade compliance program elements corresponding to government agency standards, by program module.

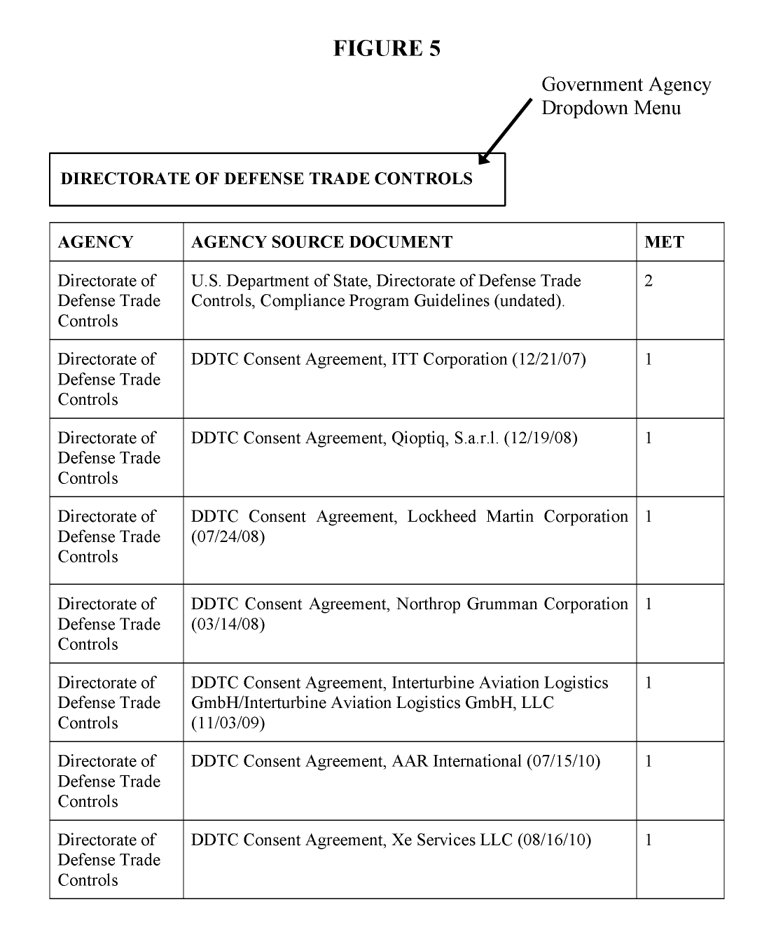

FIG. 5 illustrates a web page layout configured for tracking trade compliance program elements corresponding to government agency standards, by government agency source document.

In accordance with at least one other embodiment of the invention, the method and system matches specific user trade compliance program elements to government agency standards and provides a count of government agency standards met by the user's trade compliance program, and a count of government agency standards not met by the user's trade compliance program. This information provides a reference point to judge the quality of the user's trade compliance program.

In accordance with at least one other embodiment of the invention, the vendor of the tool monitors for updates to agency source documents and for new agency source documents and updates the government standards database to reflect revised or new agency standards. The updates trigger automatic email notifications to users with digests of the of updates.

In accordance with at least one other embodiment of the invention, users can create new program elements and program modules. These can contain company or location specific program elements not already included in the database and will have the same functionality in the tool as program elements and program modules in the database.

In accordance with at least one other embodiment of the invention, multiple users from the same company and outside consultants, as may be hired by the subscribing user, can access the tool to consolidate trade compliance program development, implementation, and validation against the government agency standards. The multiple user access can further direct and consolidate internal and external audit functions. It can further provide established points of reference in an audit framework for use over time to ensure consistency in audit focus and to allow comparison of audit results at different points in time.

In accordance with at least one other embodiment of the invention, the tool provides a count of government agency standards applicable to the user's trade compliance program that are met by the program as a “company benchmark” for the user to use in publicly reporting the quality of the user's trade compliance program.

It should be understood that the web-based implementation may include one or more security measures including user-input identification numbers and passwords, dedicated network connections, secure socket technology, and one or more encryption technologies.

While the embodiments of the present invention may provide companies and export and import trade compliance professionals with a powerful international trade compliance tool, the invention may have utility in other heavily regulated business environments, which may require the development, implementation, and maintenance of corporate compliance programs that meet government standards, impose significant and complex legal compliance responsibilities, where a centralized group must oversee compliance or where a multitude of rules and laws must be followed.

The invention has been described in detail with particular reference to embodiments thereof, but it will be understood that the invention is capable of other and different embodiments. As is readily apparent to those skilled in the art, variations and modifications can be affected in the spirit and scope of the invention. Accordingly, the foregoing specification is intended for illustrative purposes only, and does not in any way limit the invention, which is defined by the claims.

1. A method for benchmarking a trade compliance program against government agency standards, comprising:
cross-referencing government agency standards to trade compliance program elements in a database;
receiving information from a user, through a web-based interface, regarding trade compliance program elements present in the user's trade compliance program; and
cross-referencing the program elements present in the user's trade compliance program with government agency standards in the database.

2. A method as claimed in claim 1, further comprising: generating a count of government agency standards present in the user's trade compliance program.

3. A method as claimed in claim 1, further comprising: generating counts of government agency standards present in the user's trade compliance program, by program element.

4. A method as claimed in claim 1, further comprising: generating counts of government agency standards present in the user's trade compliance program, by program module.

5. A method as claimed in claim 1, further comprising: generating counts of government agency standards present in the user's trade compliance program, by government agency source document.

6. A method as claimed in claim 1, further comprising: generating a count of government agency standards not present in the user's trade compliance program.

7. A method as claimed in claim 1, further comprising: generating counts of government agency standards not present in the user's trade compliance program, by program element.

8. A method as claimed in claim 1, further comprising: generating counts of government agency standards not present in the user's trade compliance program, by program module.

9. A method as claimed in claim 1, further comprising: generating counts of government agency standards not present in the user's trade compliance program, by government agency source document.

10. A method as claimed in claim 1, further comprising: a web-based interface that allows users to create program elements and program modules not contained in the database.

11. A system for benchmarking a trade compliance program against government agency standards, comprising:
a web-based computer platform configured to call upon a database that cross-references government agency standards to trade compliance program elements in the database;
the web-based computer platform receives information from a user, through a web-based interface, regarding trade compliance program elements present in the user's trade compliance program; and
the web-based computer platform cross-references the program elements present in the user's trade compliance program with government agency standards in the database.

12. A system as claimed in claim 11, wherein the system is configured to generate a count of government agency standards present in the user's trade compliance program.

13. A system as claimed in claim 11, wherein the system is configured to generate counts of government agency standards present in the user's trade compliance program, by program element.

14. A system as claimed in claim 11, wherein the system is configured to generate counts of government agency standards present in the user's trade compliance program, by program module.

15. A system as claimed in claim 11, wherein the system is configured to generate counts of government agency standards present in the user's trade compliance program, by government agency source document.

16. A system as claimed in claim 11, wherein the system is configured to generate a count of government agency standards not present in the user's trade compliance program.

17. A system as claimed in claim 11, wherein the system is configured to generate counts of government agency standards not present in the user's trade compliance program, by program element.

18. A system as claimed in claim 11, wherein the system is configured to generate counts of government agency standards not present in the user's trade compliance program, by program module.

19. A system as claimed in claim 11, wherein the system is configured to generate counts of government agency standards not present in the user's trade compliance program, by government agency source document.

20. A system as claimed in claim 11, wherein the web-based computer platform is configured to allows users to create program elements and program modules not contained in the database.
